(19) United States
(12) Patent Application Publication
(10) Pub. No.: US 2026/0087152 A1
(43) Pub. Date: Mar. 26, 2026

(54) ELECTRONIC DEVICE AND CONTROLLING METHOD THEREOF

(71) Applicant: CRYPTO LAB INC., Seoul (KR)

(72) Inventors: Garam Lee, Seoul (KR); Yubeen Bae, Seoul (KR); Suyeong Park, Seoul (KR); Sung Hee Hong, Seoul (KR); Jaejin Lee, Suwon-si (KR)

(21) Appl. No.: 19/327,183

(22) Filed: Sep. 12, 2025

(30) Foreign Application Priority Data
Sep. 13, 2024 (KR) 10-2024-0125307
Sep. 10, 2025 (KR) 10-2025-0129316

(51) Int. Cl. G06F 21/60; G06F 16/903

(52) U.S. Cl. CPC G06F 21/602; G06F 16/90335

(57) ABSTRACT

Provided are an electronic device and a controlling method thereof. The electronic device includes: a communication interface; a memory storing instructions; and a processor configured to execute the instructions, wherein the processor is configured to: control the communication interface to transmit an input query to a first server storing a database encrypted using homomorphic encryption based on an encryption key and an operation key corresponding to the encryption key if the user query is input; receive, from the first server through the communication interface, an encrypted retrieval result for at least one document related to the query among a plurality of documents included in the database; perform decryption on the retrieval result based on a decryption key corresponding to the encryption key; control the communication interface to transmit input information including the query and the decrypted retrieval result to a second server providing a large language model; and receive a response to the query from the second server through the communication interface.

### TECHNICAL FIELD

The present disclosure relates to an electronic device and a controlling method of an electronic device, and more particularly, to an electronic device capable of securing security of a database used for providing a response to a user query and a controlling method thereof.

### BACKGROUND ART

In recent years, a conversational artificial intelligence (AI) service utilizing a large language model (LLM) has been widespread. However, a conventional LLM-based chatbot fails to reflect the latest information after a time point at which its training is completed, and fails to clearly identify a source of a generated response, thereby possibly causing hallucination in which incorrect information is included in a response provided to a user.

As a technology for solving such a problem, retrieval-augmented generation (RAG) has been proposed. RAG may couple the large language model with an information retrieval system to couple information retrieved from a database (also referred to as a vector database (DB)) with text generated by the large language model, thereby providing a more accurate and contextual response to a user query.

However, if corporate confidential information or personal data is processed by a current retrieval-augmented generation system processes, data may be exposed from a database, the query used for retrieval may itself also be exposed externally, text embeddings stored in the database may be restored to original text by reverse engineering, etc.

Accordingly, there is a need for a technology capable of preventing external exposure of personal or sensitive information included in the user query or a database while providing a response by effectively reflecting the latest information stored in the database upon providing the response to a user query by using the large language model.

### DISCLOSURE OF INVENTION

### Solution to Problem

Aspects according to the present disclosure provide an electronic device capable of securing security of a database used for providing a response to a user query and a controlling method thereof.

Additional aspects will be partially disclosed in the following description, partially apparent from the description, or learned through implementing the disclosed embodiments.

According to an aspect of the present disclosure, provided is an electronic device including: a communication interface; a memory storing instructions; and a processor configured to execute the instructions, wherein the processor is configured to: control the communication interface to transmit an input query to a first server storing a database encrypted using homomorphic encryption based on an encryption key and an operation key corresponding to the encryption key if the user query is input; receive, from the first server through the communication interface, an encrypted retrieval result for at least one document related to the query among a plurality of documents included in the database; perform decryption on the retrieval result based on a decryption key corresponding to the encryption key; control the communication interface to transmit input information including the query and the decrypted retrieval result to a second server providing a large language model; and receive a response to the query from the second server through the communication interface.

The processor may be configured to: generate the encryption key, the operation key, and the decryption key for the homomorphic encryption based on the user input if data to be encrypted are obtained; obtain a first vector corresponding to the data; obtain encrypted data by performing encryption on the first vector based on the encryption key; and control the communication interface to transmit the encrypted data and the operation key to the first server.

The processor may be configured to: receive, from the first server through the communication interface, similarity information including a plurality of scores and encrypted using the homomorphic encryption, the plurality of scores representing similarity between each of the plurality of documents included in the database and the query; perform decryption on the encrypted similarity information based on the decryption key corresponding to the encryption key; identify at least one document corresponding to the query among the plurality of documents based on the decrypted similarity information; control the communication interface to transmit identification information for the at least one document to the first server; and receive the retrieval result from the first server through the communication interface.

The processor may be configured to: obtain a second vector corresponding to the query if the query is input; obtain an encrypted query by performing the encryption on the second vector based on the encryption key; and control the communication interface to transmit the encrypted query to the first server, and the first server is configured to obtain a plurality of scores by calculating similarity between a plurality of vectors included in the database including an encrypted first vector and the encrypted second vector based on the operation key.

The first server and the second server may be implemented as one integrated server, the large language model may support the homomorphic encryption, the integrated server may be configured to: obtain an encrypted retrieval result for the at least one document related to the query among the plurality of documents if the query is received; and generate an encrypted response to the query based on the query and the encrypted retrieval result, and the processor may be configured to obtain the response by performing decryption on the response based on the decryption key if the encrypted response is received from the integrated server through the communication interface.

The processor may be configured to generate the input information based on at least one of: composing the query and the decrypted retrieval result into one prompt; extracting a portion corresponding to the query from the decrypted retrieval result; summarizing the decrypted retrieval result and concatenating the summarized retrieval result with the query; or including metadata such as source, date, and author information related to the retrieval result into the input information.

The processor may be configured to apply the homomorphic encryption to retrieval, modification, insertion, and deletion of data included in the database.

According to an aspect of the present disclosure, provided is a controlling method of an electronic device, the method including: transmitting an input query to a first server storing a database encrypted using homomorphic encryption based on an encryption key and an operation key corresponding to the encryption key if the user query is input; receiving, from the first server, an encrypted retrieval result for at least one document related to the query among a plurality of documents included in the database; performing decryption on the retrieval result based on a decryption key corresponding to the encryption key; transmitting input information including the query and the decrypted retrieval result to a second server providing a large language model; and receiving a response to the query from the second server.

The method may include: generating the encryption key, the operation key, and the decryption key for the homomorphic encryption based on the user input if data to be encrypted are obtained; obtaining a first vector corresponding to the data; obtaining encrypted data by performing encryption on the first vector based on the encryption key; and transmitting the encrypted data and the operation key to the first server.

The receiving of the retrieval result may include: receiving, the first server, similarity information including a plurality of scores and encrypted using the homomorphic encryption, the plurality of scores representing similarity between each of the plurality of documents included in the database and the query; performing decryption on the encrypted similarity information based on the decryption key corresponding to the encryption key; identifying at least one document corresponding to the query among the plurality of documents based on the decrypted similarity information; transmitting identification information for the at least one document to the first server; and receiving the retrieval result from the first server.

The transmitting of the query may include: obtaining a second vector corresponding to the query if the query is input; obtaining an encrypted query by performing the encryption on the second vector based on the encryption key; and transmitting the encrypted query to the first server, and the first server may obtain a plurality of scores by calculating similarity between a plurality of vectors included in the database including an encrypted first vector and the encrypted second vector based on the operation key.

The first server and the second server may be implemented as one integrated server, the large language model may support the homomorphic encryption, the integrated server may be configured to: obtain an encrypted retrieval result for the at least one document related to the query among the plurality of documents if the query is received; and generate an encrypted response to the query based on the query and the encrypted retrieval result, and the obtaining of the response includes obtaining the response by performing decryption on the response based on a decryption key if the encrypted response is received from the integrated server.

The transmitting of the input information may include generating the input information based on at least one of: composing the query and the decrypted retrieval result into one prompt; extracting a portion corresponding to the query from the decrypted retrieval result; summarizing the decrypted retrieval result and concatenating the summarized retrieval result with the query; or including metadata such as source, date, and author information related to the retrieval result into the input information.

The method may include applying the homomorphic encryption to retrieval, modification, insertion, and deletion of data included in the database.

According to an aspect of the present disclosure, provided is a non-transitory computer-readable recording medium including a program for executing a controlling method of an electronic device, wherein the method includes: transmitting an input query to a first server storing a database encrypted using homomorphic encryption based on an encryption key and an operation key corresponding to the encryption key if the user query is input; receiving, from the first server, an encrypted retrieval result for at least one document related to the query among a plurality of documents included in the database; performing decryption on the retrieval result based on a decryption key corresponding to the encryption key; transmitting input information including the query and the decrypted retrieval result to a second server providing a large language model; and receiving a response to the query from the second server.

### BRIEF DESCRIPTION OF DRAWINGS

The above and other aspects, features, and advantages of the present disclosure will become more apparent from the following detailed description, which is described with reference to the accompanying drawings:

FIG. 1 is a block diagram illustrating a configuration of an electronic device according to an embodiment;

FIG. 2 is a diagram illustrating a process of key generation and database construction;

FIG. 3 is a diagram illustrating a process of obtaining a response to a user query according to an embodiment;

FIG. 4 is a diagram illustrating in detail processes of constructing a database and obtaining a response to a user query according to an embodiment;

FIG. 5 is a diagram illustrating a process of applying homomorphic encryption to a process of updating a database according to an embodiment; and

FIG. 6 is a flowchart illustrating a controlling method of an electronic device according to an embodiment.

### MODE FOR INVENTION

The present disclosure may be variously modified and have several embodiments, and specific embodiments of the present disclosure are thus illustrated in the accompanying drawings and described in detail in the specification. However, it should be understood that the scope of the present disclosure are not limited to specific embodiments, and include all modifications, equivalents, and alternatives according to an embodiment of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (e.g., a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

If any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, if any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform˜” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

Meanwhile, various elements and regions in the drawings are schematically illustrated. Therefore, the spirit of the present disclosure is not limited by relative sizes or intervals illustrated in the accompanying drawings.

Hereinafter, an embodiment of the present disclosure is described in detail with reference to the accompanying drawings so that those skilled in the art to which the present disclosure pertains may easily practice the present disclosure.

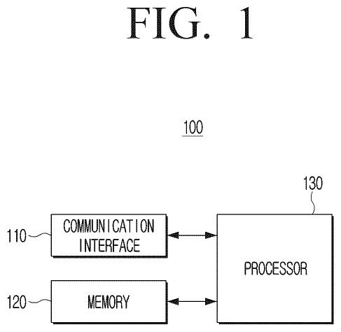

FIG. 1 is a block diagram illustrating a configuration of an electronic device 100 according to an embodiment.

The electronic device 100 refers to an apparatus capable of securing security of a database used for providing a response to a user query. Specifically, the electronic device 100 may provide a response to the user query by using a large language model, and may secure security of data used in a process thereof.

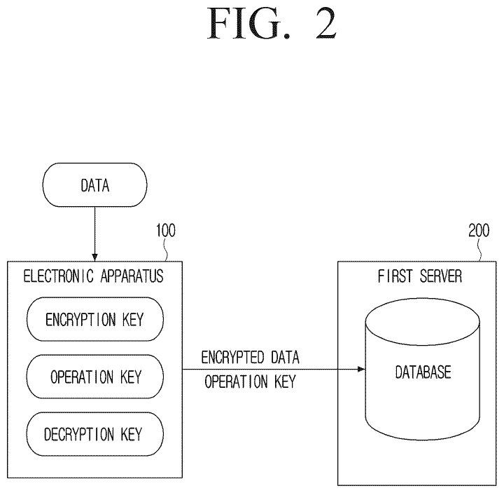

As illustrated in FIG. 2, the electronic device 100 according to an embodiment may include a communication interface 110, a memory 120, and a processor 130.

However, the components illustrated in FIG. 2 are merely exemplary, and in implementing the present disclosure, new components may be added to or some components may be omitted from the components illustrated in FIG. 2.

The communication interface 110 may include circuitry and may communicate with an external device. Specifically, the processor 130 may receive various data or information from the external device connected thereto through the communication interface 110, and may also transmit various data or information to the external device.

The communication interface 110 may include at least one of a wireless fidelity (Wi-Fi) module, a Bluetooth module, a wireless communication module, a near-field communication (NFC) module, or an ultra-wide band (UWB) module. Specifically, each of the Wi-Fi module and the Bluetooth module perform communication in a Wi-Fi scheme and a Bluetooth scheme, respectively. If the Wi-Fi module or the Bluetooth module is used, the communication interface 110 may first transmit/receive various connection information such as a service set identifier (SSID), establish a communication connection by using the same, and then transmit/receive various information.

In addition, the wireless communication module may perform communication according to various communication standards such as IEEE, Zigbee, 3rd generation (3G), 3rd generation partnership project (3GPP), long term evolution (LTE), and 5th generation (5G). In addition, the NFC module may perform communication in a near field communication (NFC) scheme using a 13.56 MHz band among various radio frequency identification (RF-ID) frequency bands such as 135 kHz, 13.56 MHz, 433 MHz, 860-960 MHz, and 2.45 GHz. In addition, through communication between UWB antennas, the UWB module may accurately measure a time of arrival (ToA) at which a pulse reaches a target and an angle of arrival (AoA) of a pulse at a transmission device, thereby making precise distance and position recognition possible indoors within an error range of several tens of centimeters.

In an embodiment, the processor 130 may control the communication interface 110 to transmit encrypted data, operation keys, the user query, identification information for a document, input information based on queries and retrieval results, and the like to an external server (e.g., a first server 200 or a second server 300). The processor 130 may receive encrypted similarity information, encrypted retrieval results, and a response to the user query from the external server through the communication interface 110.

The memory 120 may store at least one instruction related to the electronic device 100. In addition, the memory 120 may store an operating system (O/S) for operating the electronic device 100. In addition, according to various embodiments of the present disclosure, the memory 120 may store various software programs or applications for operating the electronic device 100. In addition, the memory 120 may include a semiconductor memory such as a flash memory or a magnetic storage medium such as a hard disk.

Specifically, according to the various embodiments of the present disclosure, the memory 120 may store various software modules for operating the electronic device 100, and the processor 130 may control an operation of the electronic device 100 by executing the various software modules stored in the memory 120. That is, the memory 120 may be accessed by the processor 130, and the processor 130 may perform reading, writing, modification, deletion, update, or the like of data.

Meanwhile, in the present disclosure, the term “memory 120” may be used in a concept including the memory 120, a read only memory (ROM) and a random access memory (RAM) inside the processor 130, or a memory card (e.g., a micro secure digital (SD) card or a memory stick) mounted on the electronic device 100.

In an embodiment, the memory 120 may store encrypted data, an encryption key, a decryption key, an operation key, the user query, identification information for a document, input information based on queries and retrieval results, encrypted similarity information, encrypted retrieval results, and a response to the user query. In addition, the memory 120 may store various information necessary for achieving an object of the present disclosure, and information stored in the memory 120 may be updated based on information received from the external device or input by a user.

The processor 130 may control overall operations of the electronic device 100. Specifically, the processor 130 may be connected with the components of the electronic device 100 including the communication interface 110 and the memory 120. The processor 130 may include processing circuitry and may be implemented as at least one processor 130. That is, the processor 130 may be implemented as one or two or more processors 130. The processor 130 may control the operation of the electronic device 100 by individually or collectively executing the instructions stored in the memory 120.

The processor 130 may be implemented in various forms. For example, the processor 130 may be implemented as at least one of an application-specific integrated circuit (ASIC), an embedded processor, a microprocessor, hardware control logic, a hardware finite state machine (FSM), or a digital signal processor (DSP). Meanwhile, in the present disclosure, the term “processor 130” may be used in a concept including a central processing unit (CPU), a graphics processing unit (GPU), or a micro processing unit (MPU).

The processor 130 may provide a response to the user query by using the large language model and may secure security of data used in the process. Various embodiments implemented by the processor 130 will be described in detail below with reference to FIGS. 2 to 5.

FIG. 2 is a diagram illustrating a process of key generation and database construction according to an embodiment.

The processor 130 may obtain data to be encrypted. Specifically, the processor 130 may obtain the data based on a user input, or may obtain the data from an external device such as a user terminal through the communication interface 110.

For example, the “data” to be encrypted may include text and/or an image including personal information of an individual user, confidential information of a corporate user, or the like. However, a type of data is not particularly limited, and publicly available data on the Internet or open-access latest papers may also correspond to the data according to the present disclosure. Hereinafter, the term “data” may refer to the data to be encrypted and may also be referred to by various names such as “document.”

Homomorphic encryption (HE) may refer to an encryption scheme that enables the same operation result as an operation result performed on plaintext data to be directly obtained in a ciphertext state. Therefore, if encryption is performed using the homomorphic encryption, a necessary operation may be performed while maintaining confidentiality of data. For example, the homomorphic encryption according to the present disclosure may be the homomorphic encryption based on a Cheon-Kim-Kim-Song (CKKS) scheme, a Brakerski-Fan-Vercauteren scheme (BFV) scheme, or a Brakerski-Gentry-Vaikuntanathan scheme (BGV) scheme. However, the homomorphic encryption according to the present disclosure is not limited to the above-described examples.

The processor 130 may generate an encryption key, an operation key, and a decryption key for the homomorphic encryption based on a user input. Specifically, the processor 130 may generate a set (or package) of keys including an encryption key used for converting plaintext data into encrypted data, an operation key (evaluation key) enabling addition, multiplication, rotation, and other operations in an encrypted data state, and a decryption key used for converting encrypted data into plaintext data.

The processor 130 may perform encryption on data by using the generated encryption key. Specifically, the processor 130 may obtain a first vector corresponding to the data. For example, the processor 130 may convert the data into a numerical vector form by using an embedding model to obtain the first vector corresponding to the data. The processor 130 may obtain encrypted data by performing encryption on the first vector based on the encryption key. In addition, as illustrated in FIG. 2, the processor 130 may control the communication interface 110 to transmit the encrypted data and the operation key to the first server 200.

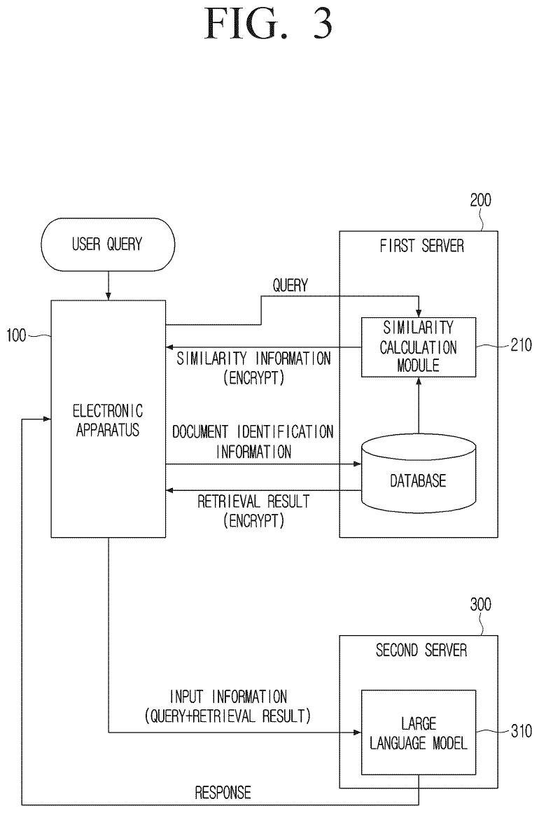

Meanwhile, to increase the efficiency of vector search, the processor 130 may apply an approximate nearest neighbor (ANN) algorithm to entire embedding vectors, and generate a codebook representing a plurality of vectors in this process. Details of the approximate nearest neighbor, the codebook, and the like will be described in detail in the description of similarity calculation provided with reference to FIG. 3.

If the encrypted data and the operation key are transmitted to the first server 200, the first server 200 may store the encrypted data so that the encrypted data are included in a database, and may store information on the operation key together with the data. The encrypted data may be continuously transmitted to the first server 200, and as a result, the first server 200 may document the encrypted data to construct the database.

The “database” managed by the first server 200 may include a plurality of documents including personal information of the individual user or confidential information of the corporate user. Accordingly, hereinafter, a result of constructing the database by the first server 200 from the encrypted data may be referred to as “document” for convenience. The first server 200 may independently construct/manage the database for each user based on a user account and may manage information on an operation key for an individual document together.

FIG. 3 is a diagram illustrating a process of obtaining a response to the user query according to an embodiment.

Hereinafter, a process of processing if the user query is input after the database, that is, an encrypted vector DB, is constructed as illustrated in FIG. 2 will be described with reference to FIG. 3.

If the user query is input, the processor 130 may control the communication interface 110 to transmit the input query to the first server 200. That is, the processor 130 may control the communication interface 110 to transmit the input query to the first server 200 storing a database encrypted using the homomorphic encryption based on the encryption key and an operation key corresponding to an encryption key.

If the user query is transmitted to the first server 200, the first server 200 may obtain a plurality of scores by using a similarity calculation module 210 trained to calculate similarity between each of a plurality of documents included in the database and the query, based on the pre-stored operation key.

The “similarity calculation module 210” may refer to a module capable of calculating a plurality of scores representing similarity between each of a plurality of documents and the query by comparing each of the plurality of documents with the query. For example, the plurality of scores may be values between 0 and 1. In this case, if a first score corresponding to a first document among the plurality of documents is 0.9 and a second score corresponding to a second document among the plurality of documents is 0.5, the processor 130 may determine that the first document is more similar to the query than the second document.

For example, the similarity calculation module 210 may calculate similarity between each of a plurality of documents and the query by using an approximate nearest neighbor (ANN) technique. The approximate nearest neighbor search may refer to a method of searching for an approximate nearest vector instead of retrieving an exact nearest vector to a vector corresponding to the query among the plurality of documents in the database to reduce a computational load. The approximate nearest neighbor search may enable efficient retrieval for large-scale and high-dimensional vector data and may include various techniques such as codebook-based retrieval. Details of the approximate nearest neighbor technique are described below.

The first server 200 may obtain a plurality of scores representing similarity between each of a plurality of documents and the query based on the operation key. However, the plurality of scores are operation results on ciphertexts (that is, encrypted vectors corresponding to the plurality of documents), and thus be obtained in an encrypted state. If the plurality of scores are obtained, the first server 200 may transmit similarity information including the plurality of scores to the electronic device 100.

If the first server 200 transmits the similarity information to the electronic device 100, the processor 130 may receive, from the first server 200 through the communication interface 110, the similarity information including the plurality of scores and encrypted using the homomorphic encryption. The similarity information may include not only the plurality of scores respectively corresponding to the plurality of documents but also identification information for each of the plurality of documents.

If the similarity information is received, the processor 130 may perform decryption on the encrypted similarity information based on the decryption key corresponding to the encryption key. In addition, the processor 130 may identify at least one document corresponding to the user query among the plurality of documents based on the decrypted similarity information.

In an example, the processor 130 may identify a predetermined number of documents in an order of the highest scores among the plurality of scores respectively corresponding to the plurality of documents. In another example, the processor 130 may identify at least one document corresponding to a score equal to or higher than a predetermined threshold value among the plurality of scores respectively corresponding to the plurality of documents. The threshold value and the number of documents may vary depending on settings of a user or a developer.

Meanwhile, the description hereinabove describes an embodiment in which the first server 200 transmits the similarity information to the electronic device 100 and the electronic device 100 analyzes the similarity information. However, in another embodiment, the first server 200 may perform an operation for analyzing a plurality of scores in an encrypted state by using an operation key. However, in this case, the time and resources required for the operation may increase.

If at least one document is identified, the processor 130 may control the communication interface 110 to transmit identification information for at least one document to the first server 200. If the identification information for at least one document is transmitted to the first server 200, the first server 200 may retrieve a document corresponding to the received identification information and may transmit a retrieval result to the electronic device 100. Here, the retrieval result may refer to a document corresponding to the identification information and may be transmitted to the electronic device 100 in an encrypted state.

If the first server 200 transmits a retrieval result to the electronic device 100, the processor 130 may receive, from the first server 200 through the communication interface 110, the encrypted retrieval result for at least one document related to the query among a plurality of documents included in the database. The processor 130 may perform decryption on the retrieval result based on the decryption key corresponding to the encryption key. In addition, the processor 130 may control the communication interface 110 to transmit input information including the query and the decrypted retrieval result to the second server 300 providing a large language model 310.

Here, the large language model 310 (LLM) may refer to an artificial intelligence model based on a neural network structure trained using large-scale language data and including a plurality of parameters, which estimates a probability distribution related to natural language to generate a response text for input text, or perform various language processing functions such as translation, summarization, and question answering. However, the neural network model providing a response according to the present disclosure is not necessarily limited to a neural network model referred to as the large language model 310. That is, any model trained to provide a response to the user query may replace the large language model 310 according to the present disclosure.

The embodiments according to the present disclosure may be applied to retrieval-augmented generation (RAG). Retrieval-augmented generation may refer to a natural language processing technology that couples the large language model 310 and an information retrieval system or a database (e.g., a vector DB) to generate a more accurate and contextual response to the user query. In retrieval-augmented generation, information related to the user query may first be retrieved from a database, and the retrieved information may be provided together as input to the large language model 310, thus enabling the language model to generate a response to the user query based on retrieval results having guaranteed timeliness and sources rather than relying only on learned knowledge.

Specifically, the processor 130 may simply concatenate the user query and a decrypted retrieval result to generate input information. However, more preferably, the processor 130 may generate input information optimized for the large language model 310 to generate a response based on the query and the decrypted retrieval result. In other words, the processor 130 may obtain input information to be input into the large language model 310 by augmenting the query and the decrypted retrieval result beyond a simple concatenation thereof.

For example, the processor 130 may generate optimized input information based on at least one of: composing the query and a decrypted retrieval result into a single prompt; extracting a portion corresponding to the query from the decrypted retrieval result; summarizing the decrypted retrieval result and concatenating the summarized retrieval result with the query; or including metadata such as source, date, and author information related to the retrieval result into the input information.

If the input information is transmitted to the second server 300, the second server 300 may input the received input information into the large language model 310 to obtain a response corresponding to the input information. In addition, the second server 300 may transmit the obtained response to the electronic device 100. As a result, the processor 130 may receive a response to the query from the second server 300 through the communication interface 110.

According to the embodiments described above, if the electronic device 100 provides a response to the user query by using the large language model 310, the electronic device 100 may prevent external exposure of personal or sensitive information included in the user query or the database while providing the response by effectively reflecting the latest information stored in the database.

More specifically, the electronic device 100 may prevent leakage of sensitive information by processing data in the database, which is used in retrieval-augmented generation, in an encrypted state while enabling operations using the homomorphic encryption even in the encrypted state.

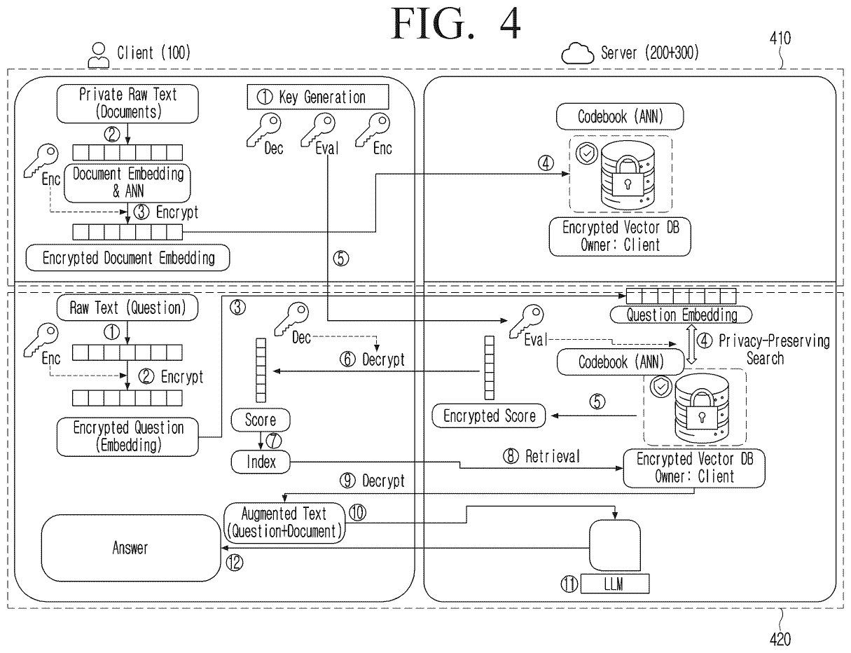

FIG. 4 is a diagram illustrating in detail processes of constructing a database and obtaining a response to the user query according to an embodiment.

FIG. 4 is not intended to describe an embodiment that is in contrast to the embodiments described above with reference to FIGS. 1 to 3, and to describe the embodiments described above with reference to FIGS. 1 to 3 in more detail or to describe an additional embodiment thereof. Therefore, the description provided with reference to FIG. 4 may omit redundant descriptions of the contents described with reference to FIGS. 1 to 3.

A client illustrated in FIG. 4 represents the electronic device 100 according to the present disclosure, and a server represents the first server 200 and the second server 300 according to the present disclosure. As illustrated in FIG. 4, the first server 200 and the second server 300 may be implemented as one integrated server.

410 in FIG. 4 represents processes of key generation and database construction, and 420 in FIG. 4 represents a process of obtaining a response to the user query. Each step included in 410 and 420 will be sequentially described below.

\textcircled{1} illustrated in 410 represents generation of a key package according to the present disclosure. Specifically, the processor 130 may generate an encryption key (Enc, see FIG. 4), an operation key (Eval, FIG. 4), and a decryption key (Dec, see FIG. 4) for the homomorphic encryption.

\textcircled{2} illustrated in 410 represents an embedding process for data (private raw text in FIG. 4). Specifically, the processor 130 may convert the data into a numerical vector form by using an embedding process.

\textcircled{3} illustrated in 410 represents an encryption process on the converted vector. Specifically, the processor 130 may obtain an encrypted vector (referred to as “encrypted document embedding” in FIG. 4) by performing the encryption process on the converted vector using the homomorphic encryption.

\textcircled{4} illustrated in 410 represents a process of transmitting the encrypted vector corresponding to the data to the first server 200. Specifically, the processor 130 may transmit the obtained encrypted data, that is, vector data, to the first server 200, and the first server 200 may construct a database such that the encrypted data are included in the database. The encrypted data are results of performing encryption on vectors, and the database may thus be referred to as an “encrypted vector DB” or a “private vector DB”, as illustrated in FIG. 4. In addition, an owner of the encrypted vector DB is the user of the electronic device 100.

\textcircled{5} illustrated in 410 represents a process of transmitting the generated operation key to the first server 200. Specifically, the processor 130 may transmit, to the first server 200, not only the encrypted vector but also the operation key among the keys generated upon generating the key package so that the first server 200 may perform operations in a ciphertext state.

Hereinafter, 420 illustrated in FIG. 4 describes a process of obtaining a response to the user query under assumption that the key generation and database construction process as illustrated 410 in FIG. 4 are performed. However, encryption for the user query will be described prior to this process. In the present disclosure, encryption may not be performed on the user query unlike data, or encryption may also be performed on the user query.

Specifically, if the user query is input, the processor 130 may obtain a second vector corresponding to the query, obtain an encrypted query by performing encryption on the second vector based on the encryption key, and control the communication interface 110 to transmit the encrypted query to the first server 200. In this case, the first server 200 may obtain a plurality of scores by calculating similarity between a plurality of vectors included in a database including the encrypted first vectors and the encrypted second vector based on an operation key.

If the user query does not include personal information or information likely to infringe on user privacy, it may be preferable not to perform encryption in terms of an operational speed or the like. In contrast, if the user query includes personal information or information likely to infringe on user privacy, encryption may be performed on the user query using the same encryption key as that for the data to be encrypted.

Hereinafter, the description will be provided under assumption that encryption is performed on the user query.

\textcircled{1} illustrated in 420 represents an embedding process for the user query (the raw text (or question) or the query illustrated in FIG. 4). Specifically, the processor 130 may receive the user query. For example, the processor 130 may receive the user query based on text input from the user, or may receive the user query based on a voice signal received through a microphone. If the user query is received in the form of voice, the processor 130 may convert the voice corresponding to the user query into text by obtaining text corresponding to the received voice using a voice recognition model (e.g., automatic speech recognition model) provided by the electronic device 100 or the external server. If the user query is input, the processor 130 may convert the user query into a numerical vector form by using the embedding process.

\textcircled{2} illustrated in 420 represents an encryption process on the converted query. Specifically, the processor 130 may perform an encryption process on the converted query using the homomorphic encryption to obtain an encrypted query vector (referred to as “encrypted question” or “question embedding” in FIG. 4).

\textcircled{3} illustrated in 420 represents a process of transmitting the encrypted query vector to the first server 200. If the encrypted query vector is transmitted to the first server 200, the first server 200 may perform: a retrieval process (referred to as “privacy-preserving search” in FIG. 4) according to \textcircled{4} illustrated in 420; a process of obtaining a score representing similarity (referred to as “encrypted score” in FIG. 4) according to \textcircled{5} illustrated in 420; and a process of transmitting the encrypted score representing the similarity to the electronic device 100. These processes may be performed based on the ANN technique using a codebook. Using a codebook may increase a retrieval speed while maintaining security.

Specifically, the processor 130 may perform a similarity operation between a vector corresponding to the user query and a codebook vector in the database. The “codebook” may be a set of vectors generated to efficiently represent an entire vector space, and each codebook vector may represent a partial region (i.e., a cluster or a category) of an original data set. A “codeword” refers to an individual vector included in each codebook and may refer to a representative vector most closely corresponding to a specific data vector. That is, the codebook may refer to a structure that compressively represents a data space to increase data retrieval speed, and a codeword may refer to a representative unit vector therein.

\textcircled{6} illustrated in 420 represents a decryption process on a score representing similarity, and \textcircled{7} illustrated in 420 represents a process of identifying an index. Specifically, if the first server 200 transmits, to the electronic device 100, similarity information including a result of similarity calculation between a codebook and the query in a ciphertext form, the processor 130 may decrypt the similarity information and identify an index of a codebook vector having the highest similarity to the user query. Here, the “index” may be a type of identification information and refer to a value indicating a position of a codebook or original data vector. That is, the index may serve as an identifier enabling the server to refer to a specific vector or document.

\textcircled{8} illustrated in 420 represents a process of performing retrieval (“retrieval” in FIG. 4) by transmitting an index to the first server 200. Specifically, the processor 130 may control the communication interface 110 to transmit the index of a codebook having the highest similarity to the first server 200. The first server 200 may select a set of codewords belonging to the codebook, obtain a retrieval result corresponding to the user query, and transmit the obtained result to the electronic device 100. Alternatively, if the first server 200 calculates similarity between the user query and each codeword using the homomorphic encryption and transmits the result to the electronic device 100, the electronic device 100 may decrypt codeword similarity in a ciphertext form, and transmit identification information for a document having the highest similarity to the first server 200, through which the first server 200 may obtain the retrieval result.

\textcircled{9} illustrated in 420 represents a decryption process of the encrypted retrieval result, \textcircled{10} illustrated in 420 represents a process of inputting input information into the large language model 310, \textcircled{11} illustrated in 420 represents a process of obtaining a response (or an answer) corresponding to the user query, and \textcircled{12} illustrated in 420 represents a process of transmitting a response corresponding to the user query to the electronic device 100.

Specifically, the processor 130 may perform decryption on a retrieval result based on a decryption key corresponding to an encryption key. In addition, the processor 130 may obtain input information (augmented text in FIG. 4) to be input into the large language model 310 by augmenting the user query (or a question) and the document (document in FIG. 4) that corresponds to the retrieval result.

As exemplified above, the processor 130 may generate the optimized input information based on at least one of composing the query and a decrypted retrieval result into a single prompt, extracting a portion corresponding to the query from the decrypted retrieval result, summarizing the decrypted retrieval result and concatenating the summarized retrieval result with the query, or including metadata such as source, date, and author information related to the retrieval result into the input information.

The processor 130 may control the communication interface 110 to transmit input information including the query and a decrypted retrieval result to the second server 300 providing the large language model 310, and may obtain a response from the large language model 310 as a result. The processor 130 may provide the obtained response to the user. For example, the processor 130 may control a display to display the obtained response as an image or may control a speaker to output the obtained response as voice.

If the obtained response is output as voice, the processor 130 may convert text corresponding to the response into voice using a voice-synthesis model (e.g., a text-to-speech model) provided by the electronic device 100 or the external server.

Meanwhile, the input-information transmission process according to \textcircled{10} illustrated in 420 and the response-transmission process according to \textcircled{12} illustrated in 420 described above may be performed in a plaintext form. However, according to the various embodiments as described above, security for most of the entire process of providing a response corresponding to the user query may be secured by the homomorphic encryption, and in particular, security for the entire process may be secured if the homomorphic encryption is applied to the large language model 310 provided by the second server 300 even if the first server 200 and the second server 300 are implemented as one integrated server.

Specifically, the processes may not be performed in which the server transmits, to the electronic device 100, the similarity information (or the score) and the retrieval result (the document or data corresponding to the user query) in an encrypted state and the electronic device 100 decrypts the same as described above.

In an embodiment, the first server 200 and the second server 300 may be implemented as one integrated server and the large language model 310 supports the homomorphic encryption. In this case, the integrated server may obtain an encrypted retrieval result for at least one document related to the query among a plurality of documents if the query is received, and may generate an encrypted response to the query based on the query and the encrypted retrieval result. In addition, the processor 130 may obtain a response by performing decryption on the response based on a decryption key if an encrypted response is received from the integrated server through the communication interface 110.

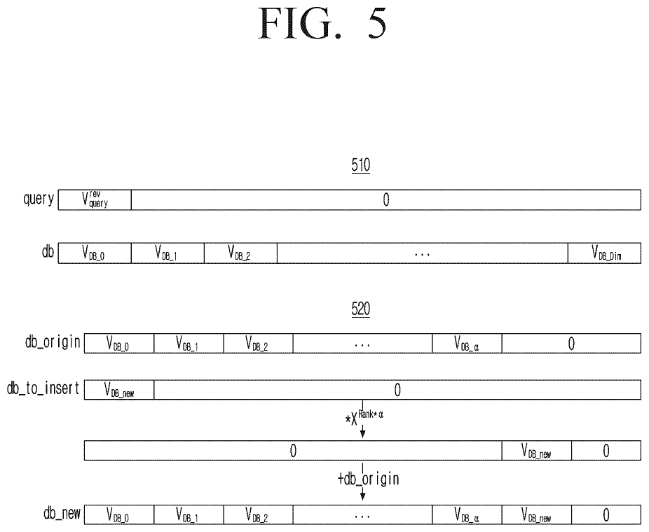

FIG. 5 is a diagram illustrating a process of applying the homomorphic encryption to a process of updating a database according to an embodiment.

FIG. 5 illustrates a process of updating a database encrypted using the homomorphic encryption based on a slot (e.g., VDB0) included in each block (e.g., query).

In the homomorphic encryption, a block is a basic unit in which encryption is performed and may refer to a coefficient region of a polynomial stored in a ciphertext. One block serves as a vectorized storage space capable of simultaneously containing a plurality of data and may be processed in the same manner during ciphertext operations.

A slot refers to a position for individually storing data inside a block. For example, in the homomorphic encryption, one ciphertext may include a plurality of slots, and one number (real, complex, or integer) may be stored in each slot. The stored slots may be simultaneously operated in a single instruction multiple data (SIMD) manner during ciphertext operations.

510 illustrated in FIG. 5 represents an encoding process of the query vector and a database vector according to an embodiment.

The processor 130 may perform similarity calculation (or batch vector distance calculation) between a database vector and the query vector using conventional slot encoding. Slot encoding enables element-wise multiplication. However, to perform matrix-vector multiplication, it may be necessary to store a database in a transposed state or perform a plurality of rotation operations. However, such operations may require high computational costs in an encrypted state, and it may thus be difficult to flexibly change the database.

In contrast, as illustrated in 510 in FIG. 5, the processor 130 may perform operations using coefficient encoding. For example, in coefficient encoding, the processor 130 may perform rotation operations only by multiplying a polynomial Xa without key switching. Therefore, the processor 130 may efficiently perform operations such as insertion, deletion, and update, and may change a database without performing high-cost operations such as number theoretic transform (NTT), mod up, and mod down.

The processor 130 may sequentially store the query vector

$$( {V}_{query}^{rev} )$$

and a database vector (V_{DB_0}, V_{DB_1}, . . . , V_{DB_Dim}) from the 0th to rth coefficients and may set remaining spaces to 0. The database vector may be stored in a reverse order to make inner-product operations with the query vector efficient.

520 illustrated in FIG. 5 represents processes of reading, insertion, deletion, and modification of a database that the processor 130 of the electronic device 100 according to claim 7 may perform.

For example, upon performing reading, the processor 130 may perform similarity calculation by multiplying the query vector and db_compute_ctxt and performing a modpack operation thereon. For example, if a polynomial degree is 4096 and a vector dimension is 128, the processor 130 may perform 4096 batch vector distance calculations only using about 128 key switching operations.

Upon performing insertion, the processor 130 may multiply Xa by an exponent corresponding to an insertion position for db_to_insert_ctxt corresponding to a new database vector and then add the same to an existing db_compute_ctxt.

Upon performing deletion, the processor 130 may multiply Xa by a corresponding exponent for db_to_delete_ctxt corresponding to a database vector to be deleted and then subtract the same from the existing db_compute_ctxt, and upon performing update, the processor 130 may first perform deletion and then perform insertion.

According to the embodiments described above with reference to FIG. 5, the electronic device 100 may quickly and flexibly change a database without key switching while applying the homomorphic encryption to the reading, insertion, deletion, and modification of data. Accordingly, even in a situation where information is continuously changed or updated, the electronic device 100 may flexibly expand a vector database while faithfully achieving a purpose of retrieval-augmented generation.

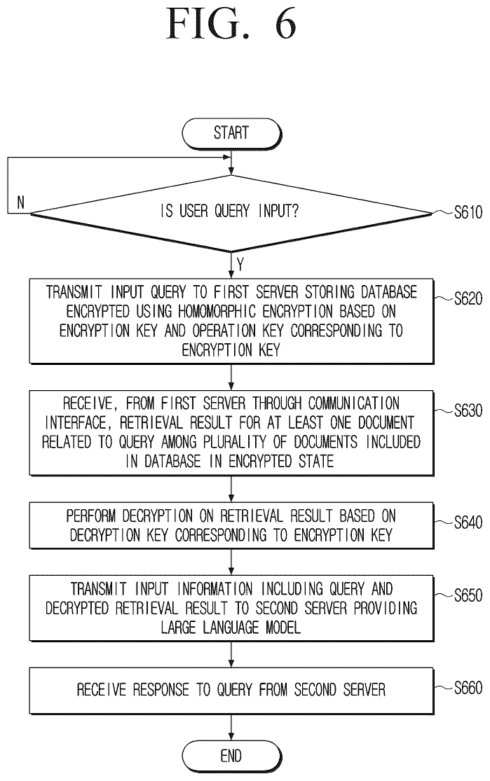

FIG. 6 is a flowchart illustrating a controlling method of an electronic device 100 according to an embodiment.

If a user query is input (S610-Y), the electronic device may transmit the input query to a first server storing a database encrypted using homomorphic encryption based on homomorphic encryption and an operation key corresponding to an encryption key (S620).

If the user query is transmitted to the first server 200, the first server 200 may obtain a plurality of scores using a similarity calculation module 210 trained to calculate similarity between each of a plurality of documents included in the database and the query based on the stored operation key.

If the first server 200 transmits similarity information to the electronic device 100, the electronic device 100 may receive, from the first server 200, the similarity information including the plurality of scores and encrypted using the homomorphic encryption.

If the similarity information is received, the electronic device 100 may perform decryption on the encrypted similarity information based on a decryption key corresponding to the encryption key. In addition, the electronic device 100 may identify at least one document corresponding to the user query among the plurality of documents based on the decrypted similarity information.

If at least one document is identified, the electronic device 100 may transmit identification information for at least one document to the first server 200. If the identification information for at least one document is transmitted to the first server 200, the first server 200 may retrieve a document corresponding to the received identification information and may transmit a retrieval result to the electronic device 100.

The electronic device may receive, from the first server, the encrypted retrieval result for at least one document related to the query among the plurality of documents included in the database (S630). The electronic device may perform decryption on the retrieval result based on the decryption key corresponding to the encryption key (S640). In addition, the electronic device may transmit input information including the query and the decrypted retrieval result to a second server providing a large language model (S650). In particular, the electronic device may generate the input information optimized for the large language model 310 to generate a response based on the query and the decrypted retrieval result.

If the input information is transmitted to the second server 300, the second server 300 may input the received input information into the large language model 310 to obtain a response corresponding to the input information. In addition, the second server 300 may transmit the obtained response to the electronic device 100. As a result, the electronic device may receive the response to the query from the second server (S660).

An artificial intelligence-related function according to the present disclosure may be operated by the processor 130 and the memory 120 included in the electronic device 100.

The processor 130 may include one or more processors 130. Here, at least one processor 130 may include at least one of a central processing unit (CPU), a graphics processing unit (GPU), or a neural processing unit (NPU), and is not limited to the above-described examples of the processors.

The CPU refers to a generic-purpose processor 130 capable of performing not only general operations but also artificial intelligence (AI) operations, and may efficiently execute complex programs by using a multi-layered cache structure. The CPU may be advantageous for a serial processing method that enables organic linkage between a previous operation result and a next operation result through sequential operations. The generic-purpose processor 130 is not limited to the above-described examples unless specified as the above-mentioned CPU.

The GPU refers to the processor 130 for large-scale operations, such as floating-point operations used in graphics processing, and may perform the large-scale operations in parallel by integrating a large number of cores. In particular, the GPU may be advantageous for parallel operations such as convolution operations compared to the CPU. In addition, the GPU may be used as the co-processor 130 to supplement functions of the CPU. The processor for large-scale operations is not limited to the above-described example unless specified as the above-mentioned GPU.

The NPU refers to a processor 130 specialized for the artificial intelligence operation using an artificial neural network, and may implement each layer included in the artificial neural network in hardware (e.g., silicon). Here, the NPU is specially designed based on requirements of a company, and may thus have a lower degree of freedom than the CPU or the GPU. However, the NPU may efficiently process the artificial intelligence operation required by the company. Meanwhile, as the processor 130 specialized for the artificial intelligence operation, the NPU may be implemented in various forms such as a tensor processing unit (TPU), an intelligence processing unit (IPU), or a vision processing unit (VPU). The artificial intelligence processor 130 is not limited to the above-described example unless specified as the above-mentioned NPU.

In addition, at least one processor 130 may be implemented as a system-on-chip (SoC). Here, the SoC may further include the memory 120, and a network interface, such as a bus, for data communication between the processor 130 and the memory 120, in addition to at least one processor 130.

If the electronic device 100 includes the plurality of processors 130 in the system-on-chip (SoC), the electronic device 100 may perform an artificial intelligence operation (e.g., an operation related to learning or inference of an artificial intelligence model) by using some of the plurality of processors 130. For example, the electronic device 100 may perform the artificial intelligence operation by using at least one of the GPU, the NPU, the VPU, the TPU, or a hardware accelerator that is specialized for the artificial intelligence operation, such as a convolution operation or a matrix multiplication operation, among the plurality of processors. However, this configuration is only one embodiment, and the electronic device may process the artificial intelligence operation by using the generic-purpose processor 130 such as the CPU.

In addition, the electronic device 100 may perform the operation related to the artificial intelligence function by using multiple cores (e.g., dual-core or quad-core) included in one processor 130. In particular, the electronic device 100 may perform the artificial intelligence operation such as the convolution operation or the matrix multiplication operation in parallel by using multiple cores included in the processor 130.

At least one processor 130 may control the processing of input data according to a predefined operation rule or the artificial intelligence model, stored in the memory 120. The predefined operation rule or the artificial intelligence model may be generated by learning.

Here, “generated by learning” may refer to that the predefined operation rule or artificial intelligence model of a desired feature is generated by applying a learning algorithm to a lot of learning data. Such learning may be performed by a device itself in which the artificial intelligence is performed according to the present disclosure, or may be performed by a separate server/system.

The artificial intelligence model may include a plurality of neural network layers. At least one layer has at least one weight value, and an operation of the layer may be performed based on an operation result of a previous layer and at least one defined operation. Examples of the neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, and a transformer. However, the neural network of the present disclosure is not limited to the above-described examples unless otherwise specified.

The learning algorithm is a method for training a predetermined target device (e.g., robot) by using a large number of learning data for the predetermined target device to make a decision or a prediction for itself. Examples of the learning algorithms may include a supervised learning algorithm, an unsupervised learning algorithm, a semi-supervised learning algorithm, or a reinforcement learning algorithm. However, the learning algorithm of the present disclosure is not limited to the above-described examples unless otherwise specified.

The machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored.

According to an embodiment, the methods according to the various embodiments disclosed in the present disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices (e.g., smartphones). In case of the online distribution, at least a part of the computer program product (e.g., downloadable app) may be at least temporarily stored or temporarily provided in the machine-readable storage medium such as a server memory 120 of a manufacturer, a server memory of an application store, or a relay server memory.

Each of components (for example, modules or programs) according to the various embodiments of the present disclosure as described above may include a single entity or a plurality of entities, and some of the corresponding sub-components described above may be omitted or other sub-components may be further included in the various embodiments. Alternatively or additionally, some of the components (for example, the modules or the programs) may be integrated into one entity, and may perform functions performed by the respective corresponding components before being integrated in the same or similar manner.

Operations performed by modules, programs, or other components according to various embodiments may be executed sequentially, in parallel, repetitively, or heuristically, or at least some operations may be executed in a different order, omitted, or additional operations may be added.

Meanwhile, the term “˜er/˜or” or “module” used in the present disclosure may include a unit including hardware, software or firmware, and may be used interchangeably with the term, for example, a logic, a logic block, a component or a circuit. The “˜er/˜or” or “module” may be an integrally formed component, or a minimum unit or part performing one or more functions. For example, the module may include an application-specific integrated circuit (ASIC).

The various embodiments of the present disclosure may be implemented by software including an instruction stored in the machine-readable storage medium (for example, a computer-readable storage medium). A machine may be an apparatus that invokes the stored instruction from the storage medium, may be operated based on the invoked instruction, and may include the electronic device (e.g., the electronic device 100) according to the disclosed embodiments.

If the instruction is executed by the processor, the processor may directly perform a function corresponding to the instruction, or perform the function by using other components under control of the processor. The instruction may include a code provided or executed by a compiler or an interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic device comprising:
a communication interface;
a memory storing instructions; and
a processor configured to execute the instructions,
wherein the processor is configured to:
control the communication interface to transmit an input query to a first server storing a database encrypted using homomorphic encryption based on an encryption key and an operation key corresponding to the encryption key if the user query is input;
receive, from the first server through the communication interface, an encrypted retrieval result for at least one document related to the query among a plurality of documents included in the database;
perform decryption on the retrieval result based on a decryption key corresponding to the encryption key;
control the communication interface to transmit input information including the query and the decrypted retrieval result to a second server providing a large language model; and
receive a response to the query from the second server through the communication interface.

2. The electronic device as claimed in claim 1, wherein the processor is configured to:
generate the encryption key, the operation key, and the decryption key for the homomorphic encryption based on the user input if data to be encrypted are obtained;
obtain a first vector corresponding to the data;
obtain encrypted data by performing encryption on the first vector based on the encryption key; and
control the communication interface to transmit the encrypted data and the operation key to the first server.

3. The electronic device as claimed in claim 1, wherein the processor is configured to:
receive, from the first server through the communication interface, similarity information including a plurality of scores and encrypted using the homomorphic encryption, the plurality of scores representing similarity between each of the plurality of documents included in the database and the query;
perform decryption on the encrypted similarity information based on the decryption key corresponding to the encryption key;
identify at least one document corresponding to the query among the plurality of documents based on the decrypted similarity information;
control the communication interface to transmit identification information for the at least one document to the first server; and
receive the retrieval result from the first server through the communication interface.

4. The electronic device as claimed in claim 1, wherein the processor is configured to:
obtain a second vector corresponding to the query if the query is input;
obtain an encrypted query by performing the encryption on the second vector based on the encryption key; and
control the communication interface to transmit the encrypted query to the first server, and
the first server is configured to obtain a plurality of scores by calculating similarity between a plurality of vectors included in the database including an encrypted first vector and the encrypted second vector based on the operation key.

5. The electronic device as claimed in claim 1, in which the first server and the second server are implemented as one integrated server,
the large language model supports the homomorphic encryption, and
the integrated server is configured to:
obtain an encrypted retrieval result for the at least one document related to the query among the plurality of documents if the query is received; and
generate an encrypted response to the query based on the query and the encrypted retrieval result,
wherein the processor is configured to obtain the response by performing decryption on the response based on the decryption key if the encrypted response is received from the integrated server through the communication interface.

6. The electronic device as claimed in claim 1, wherein the processor is configured to generate the input information based on at least one of:
composing the query and the decrypted retrieval result into one prompt;
extracting a portion corresponding to the query from the decrypted retrieval result;
summarizing the decrypted retrieval result and concatenating the summarized retrieval result with the query; or
including metadata such as source, date, and author information related to the retrieval result into the input information.

7. The electronic device as claimed in claim 1, wherein the processor is configured to apply the homomorphic encryption to reading, modification, data insertion, and data deletion of the database.

8. A controlling method of an electronic device, the method comprising:
transmitting an input query to a first server storing a database encrypted using homomorphic encryption based on an encryption key and an operation key corresponding to the encryption key if the user query is input;
receiving, from the first server, an encrypted retrieval result for at least one document related to the query among a plurality of documents included in the database;
performing decryption on the retrieval result based on a decryption key corresponding to the encryption key;
transmitting input information including the query and the decrypted retrieval result to a second server providing a large language model; and
receiving a response to the query from the second server.

9. The method as claimed in claim 8, comprising:
generating the encryption key, the operation key, and the decryption key for the homomorphic encryption based on the user input if data to be encrypted are obtained;
obtaining a first vector corresponding to the data;
obtaining encrypted data by performing encryption on the first vector based on the encryption key; and
transmitting the encrypted data and the operation key to the first server.

10. The method as claimed in claim 9, wherein the receiving of the retrieval result includes:
receiving, from the first server, similarity information including a plurality of scores and encrypted using the homomorphic encryption, the plurality of scores representing similarity between each of the plurality of documents included in the database and the query;
performing decryption on the encrypted similarity information based on the decryption key corresponding to the encryption key;
identifying at least one document corresponding to the query among the plurality of documents based on the decrypted similarity information;
transmitting identification information for the at least one document to the first server; and
receiving the retrieval result from the first server.

11. The method as claimed in claim 9, wherein the transmitting of the query includes:
obtaining a second vector corresponding to the query if the query is input;
obtaining an encrypted query by performing the encryption on the second vector based on the encryption key; and
transmitting the encrypted query to the first server, and
the first server obtains a plurality of scores by calculating similarity between a plurality of vectors included in the database including an encrypted first vector and the encrypted second vector based on the operation key.

12. The method as claimed in claim 9, in which the first server and the second server are implemented as one integrated server,
the large language model supports the homomorphic encryption, and
the integrated server is configured to:
obtain an encrypted retrieval result for the at least one document related to the query among the plurality of documents if the query is received; and
generate an encrypted response to the query based on the query and the encrypted retrieval result,
wherein the obtaining of the response includes obtaining the response by performing decryption on the response based on a decryption key if the encrypted response is received from the integrated server.

13. The method as claimed in claim 9, wherein the transmitting of the input information includes generating the input information based on at least one of:
composing the query and the decrypted retrieval result into one prompt;
extracting a portion corresponding to the query from the decrypted retrieval result;
summarizing the decrypted retrieval result and concatenating the summarized retrieval result with the query; or
including metadata such as source, date, and author information related to the retrieval result into the input information.

14. The method as claimed in claim 9, comprising applying the homomorphic encryption to reading, modification, data insertion, and data deletion of the database.

15. A non-transitory computer-readable recording medium including a program for executing a controlling method of an electronic device, wherein the method includes:
transmitting an input query to a first server storing a database encrypted using homomorphic encryption based on an encryption key and an operation key corresponding to the encryption key if the user query is input;
receiving, from the first server, an encrypted retrieval result for at least one document related to the query among a plurality of documents included in the database;
performing decryption on the retrieval result based on a decryption key corresponding to the encryption key;
transmitting input information including the query and the decrypted retrieval result to a second server providing a large language model; and
receiving a response to the query from the second server.
